(19) United States
(12) Patent Application Publication
(10) Pub. No.: US 2004/0075343 A1
(43) Pub. Date: Apr. 22, 2004

(54) System and method for power load management

(76) Inventors: Paul Wareham, Sydney (CA); Stephen MacNeil, Glace Bay (CA); Michael A. MacLean, Lingan (CA); Shane D. Samson, Balls Creek (CA)

Correspondence Address: BORDEN LADNER GERVAIS LLP, WORLD EXCHANGE PLAZA, 100 QUEEN STREET SUITE 1100, OTTAWA, ON, K1P 1J9, CA

(21) Appl. No.: 10/654,440

(22) Filed: Sep. 4, 2003

Related U.S. Application Data
(60) Provisional application No. 60/407,949, filed on Sep. 5, 2002.

(51) Int. Cl. H02J 1/00

(52) U.S. Cl. 307/39

(57) ABSTRACT

A power load management system for regulating power demand from a distribution panel of a residence or building is disclosed. Load control switches placed in-line between circuit breakers of the distribution panel and the loads they control, such as a water heater, pump, AC unit etc., provide load feedback data to a load management CPU. The load management CPU monitors the load feedback data and other operational parameters for selectively switching load control switches to the open circuit state to ensure that the total load demanded does not exceed the demand limits imposed by the power source. The load management CPU includes adaptive algorithms to automatically prioritize loads based on user and utility applied weighting factors, and patterns of loading based on time and date.

This application claims priority from U.S. Provisional Application No. 60/407,949 filed Sep. 5, 2002.

### FIELD OF THE INVENTION

The present invention relates generally to power load management systems. More particularly, the present invention relates to managing loads for alternate power supplies and during conditions of limited supply imposed by energy provider.

### BACKGROUND OF THE INVENTION

A typical problem with automatic transfer switches installed prior to the user's service installation is the matching of the load power draw with the available power supplied by an alternate power supply, such as on-site generator (gas or diesel engine-generator). An example of an automatic transfer switch installed upon a service installation is shown in FIG. 11.

In FIG. 11, an upgraded service installation 14 is mounted to the wall of the building 10 for receiving main power through main power cable 18 and emergency power from power generator 12 through cable 16. Upgraded service installation 14 includes a meter socket 20, transfer switch 22 according to an embodiment of the present invention, and a waft-hour meter 24. The transfer switch 22 is small enough to fit within meter socket 20, and includes a set of contact terminals on the load side, and a mirrored set of contact terminals on the side for connection to the watt-hour meter 24, which permits quick push-in connection to the electrical system. Meter socket 20 is connected to main power cable 18 and an internal power conduit 28. The internal power conduit 28 routes power received by the upgraded service installation 14 to a distribution panel inside the building 10. One end of transfer switch 22 is mounted onto meter socket 20 for receiving the main power supply via meter socket 20, and directly receives the emergency power from cable 16 through any standard plug and socket interface 26. For example, standard twist lock or pin sleeve weatherproof connectors can be used for interface 26. Watt-hour meter 24 displays the power consumed for meter readings, and is mounted to the other end of transfer switch 22. A rigid conduit 30 serves to protect the cable 16 as it is routed along the wall of building 10. In the event that main power from an electric utility delivered through main power cable 18 becomes unavailable or is disturbed, transfer switch 22 substitutes the main power from the electric utility with power from a power generator. Preferably, the switch over is automatically performed to minimize inconvenience to the user.

If any load in the facility is capable of drawing power from the alternate power source, then concerns are raised over possible overloading of the alternate power source capacity leading to the tripping of over-current protection for the alternate power source. One solution is to increase the size of the alternate power source to accommodate all the possible loading. However, this is a very expensive and impractical solution. It is well known that the application of electrical loads exhibits a degree of statistical load diversity, such that not all loads will be engaged simultaneously, and the loads that are can be staggered in time to reduce the overall peak demand on the alternate power source. A load, in this context, is any device that consumes electric energy, such as a water heater or an electric motor.

In the case of an alternate power source, the problem can be boiled down to asking the question: what sequences should loads be applied and at what times, based on the constraints of the alternate power source while at the same time maximizing the convenience (or ‘utility function’) to the customer. In essence, one could view the problem as making an 8 KW power source be perceived as a 20 KW power source in terms of convenience levels. In cases of utility supply, in many areas there are requirements or special rates offered for limiting consumption to certain peak levels.

It is, therefore, desirable to provide a system that prevents overloading of the alternate power source.

### SUMMARY OF THE INVENTION

It is an object of the present invention to obviate or mitigate at least one disadvantage of previous load management systems.

In a first aspect, the present invention provides a power load management system for regulating power the demand for power from a power source via a distribution panel. The system includes a switching means for selectively disconnecting and reconnecting specific loads from a distribution panel in response to demand limiting factors, a switching means providing load feedback data, and a control unit for monitoring the load feedback data and operational parameters for providing the switching signal in accordance with a power management algorithm.

In a further embodiment, the switching means includes a plurality of load control switches, where each load control switch is placed in series between a distribution circuit breaker in the distribution panel and a load.

As part of embodiment of the present aspect, the operation parameters include time, date, user weighting factor, utility weighting factor, power source limit, utility limit, total system load and rate limit factor.

In yet other embodiments of the present aspect, the load control processor includes external inputs for allowing user and utility override capability and the load feedback data includes duty cycle data, frequency of operation data and power consumption data associated with the circuit breaker. The control unit can include a main load control central processing unit for executing the power management algorithm.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a block diagram of the load management control system components and their location within a typical installation;

FIG. 2 illustrates a switch mounting configuration according to an embodiment of the present invention;

FIG. 3 is a detailed illustration of the switch mounting shown in FIG. 2;

FIG. 4 illustrates an alternate switch mounting configuration according to an embodiment of the present invention;

FIG. 5 illustrates another alternate switch mounting configuration according to an embodiment of the present invention;

FIG. 6 is a block diagram of the power load management sub-systems according to an embodiment of the present invention;

FIG. 7 is a schematic of a load control switch according to an embodiment of the present invention;

FIG. 8 is a flow diagram for the real time clock calendar algorithm;

FIG. 9 is a flow diagram for the load data acquisition algorithm;

FIG. 10 is a flow diagram for the basic load control algorithm; and,

FIG. 11 is a detailed diagram of a service installation.

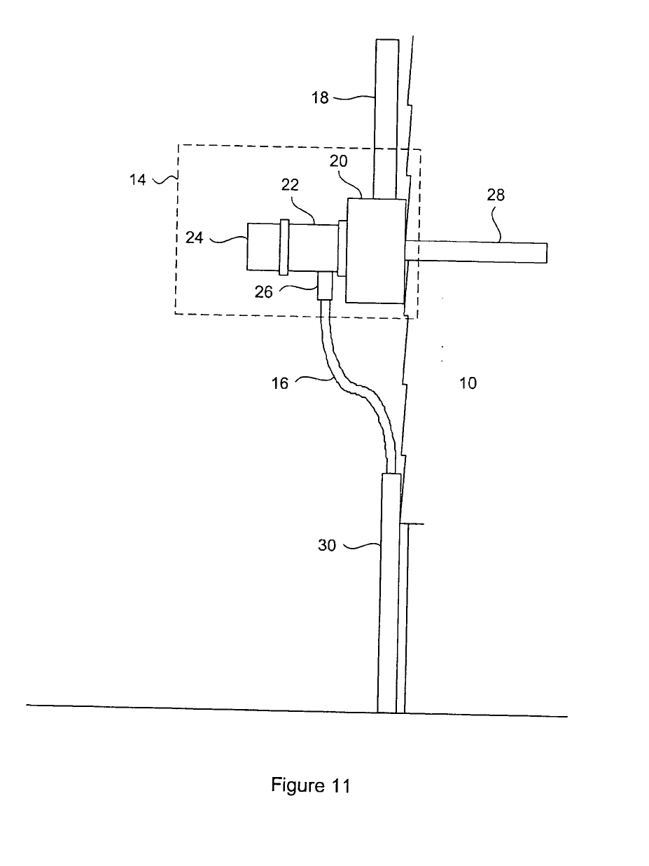

### DETAILED DESCRIPTION

Generally, the present invention provides a power load management system for regulating power demand on the distribution panel of a residence or building. Load control switches placed in-line between circuit breakers of the distribution panel and loads associated with those circuit breakers and provide load feedback data to a load management controller. The load management controller monitors the load feedback data and other operational parameters for selectively switching load control switches to the open or closed circuit states to regulate the total load demanded within the set limits of the power source. The load management controller includes adaptive algorithms to automatically prioritize loads based on user and utility applied weighting factors, and patterns of loading based on accumulated data related to time and date.

Load management according to the embodiment of the present invention are achieved in part through the application of miniaturized, electrically operated and mechanically held, remote power switches which are connected in series with electrical circuits within a facility between the distribution panel and the loads to be controlled. The power switches are controlled via a microprocessor based control system that is capable of prioritizing loads based on the usage profile of the facility occupants, the nature of the electrical loads, and the set or imposed capacity limits of the power source. The system can ensure that an alternate power source, such as a standby generator set, is never overloaded, and ensures the user statistically attains the maximum possible convenience from the power source available. The system has further application by providing a similar load management function while operating from the electric utility company's power system in order to reduce peak demand on the utility power system.

With load management, in addition to matching the capacity of an on-site alternate power source, it can be extended to the concept of controlling the loads at the user facility to achieve a better use of energy, which would be a benefit to the utility, the customer or both. Load management can be used for many different purposes, like avoiding overloads in bottlenecks in the grid, reduce losses caused by reactive power, reduce overtones and stabilize the network. One normally distinguishes between two different categories of load management: direct and indirect. Direct load management implies that the utility determines what loads are to be connected or disconnected at specific occasions. Indirect load management is the case where the utility sends some signal to the customer, such as demand limit or rate information, and relies on the user's load management system's ability to adjust the user's demand to meet the requirement imposed by this signal.

The system can be used to maximize the alternate power source efficiency during normal source failure, however the system can also include the aspect of allowing the utilities the ability to mange household loads (A/C, water heater, pool pump, electric heaters, etc.). The problem lies in how to best organize the order in which the system will allow loads to be disconnected. There are several key elements as follows: allowing the user to arrange a preset importance based on their own individual preference; have the load management systems monitor the control circuits and based on duty cycle, load demand, time of day operation, an adaptive program to automatically prioritize loads based on a user applied weighing factor and cumulative adapting information which could account for time of day and seasonal importance, i.e. AC and pool pump are low priority in the winter month may gradually shift to high priority in summer months and vice versa for electric heat while water heater remain constant. This can be additionally weighted by a priority value applied by the electric utility.

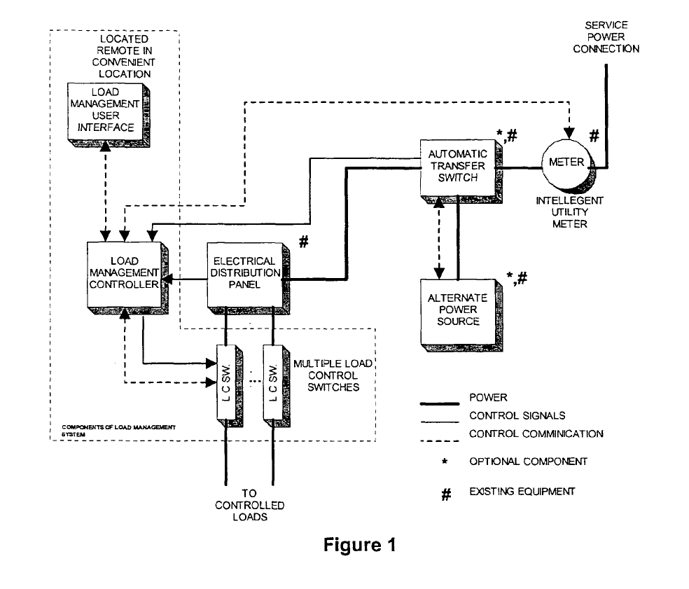

FIG. 1 represents a block diagram of the overall system components and indicates how and where they will be located within a typical installation.

The main load management system components are the a) load control box, housing the main control CPU and communications and input/output interfaces to the remote smart load control switches, b) the smart load control switches, c) electric utility interface, and d) automatic transfer switch, if applicable. Note that the power control switches may also be located within the same enclosure as the load control CPU depending on the system application.

The user interface is a conveniently located operator interface unit that communicates with the main load control CPU via a communication link which may include the following transmission media: a) power line, b) RF wireless or c) dedicated twisted pair. The operator interface provides the end user with an access point to the load management system from which they can input data about particular loads, generator size, etc. and obtain system operating information such as what loads are on or off, system demand limit, percentage of system capacity used, etc.

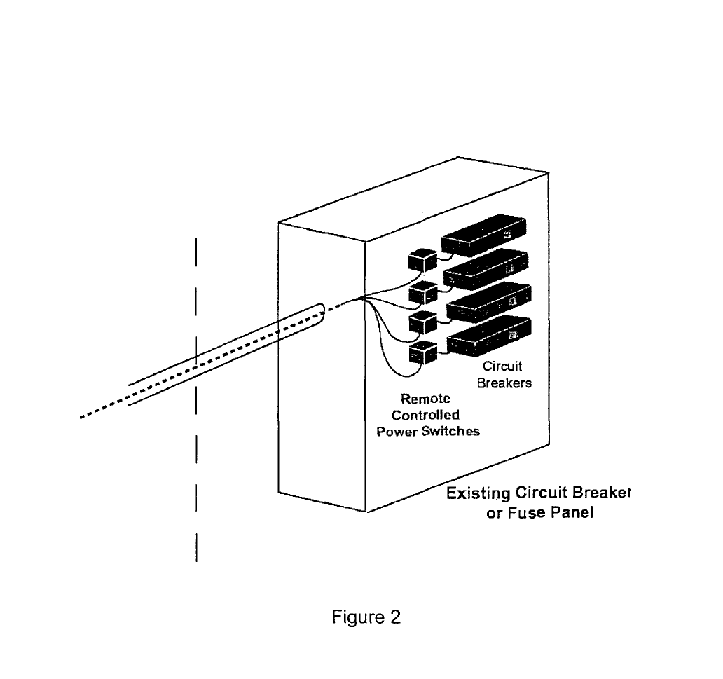

The smart load control switches may be located using three different methods depending on the installation application of the load management system, these are as follows: 1) load control switches mounted internally in UL67 panel board, 2) load control switches mounted externally to UL67 panel board, 3) load control switches mounted in main load control panel. For a retrofit situation where the existing wiring for circuits to be controlled cannot be easily rerouted, the load control switches can be mounted inside the existing distribution panel, or if space allows mounted externally on the distribution panel. For new building installation (where wiring is being installed as to accommodate the load management system during construction) or where existing circuit wiring can easily be relocated (sufficient slack in wiring to easily locate to external panel) the load control switches may be incorporated in the same panel enclosure as the load control CPU. The switch mounting locations are further illustrated by FIG. 2 through FIG. 5.

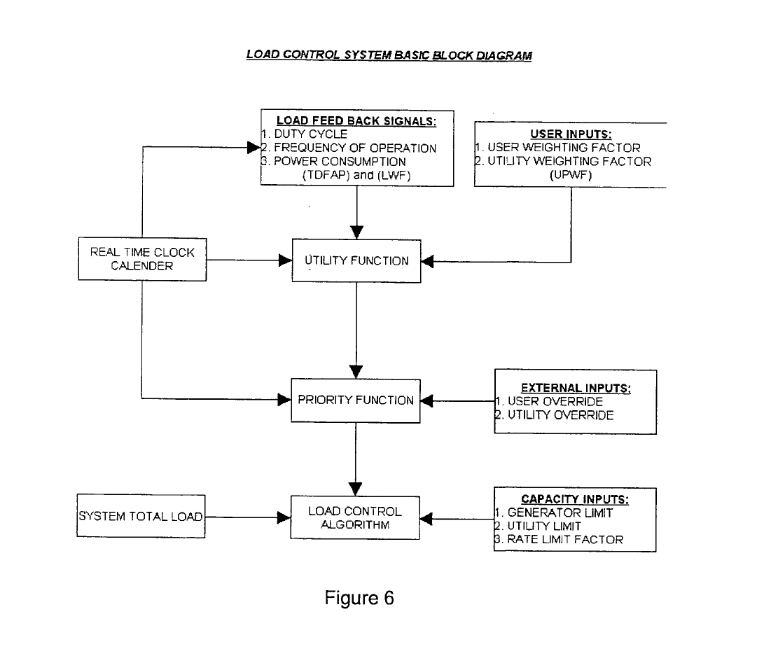

The load control switches are very small power switches that may be installed inside of an existing UL67 Panel board (e.g. an typical residential panel listed by the Underwriters Laboratory). The primary application is for residential load centers and the switches can be installed inside any standard residential load center containing fuses or circuit breakers. The switches are electrically operated mechanically held devices that maintain switch position when no power is applied. An overall system diagram is shown in FIG. 6.

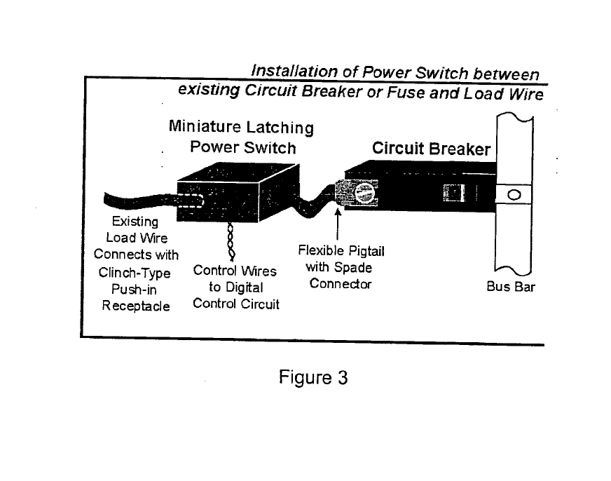

The power switches are typically installed in-line with the existing circuit breaker or fuse. A connection scheme is shown in FIG. 3. The control wires are connections on a small industrial network which are wired to a data bus and connected to a Load Control Panel which is mounted outside of the Panel board. The smart load control switches are addressable for recognition by the control network and contain circuits to provide load feedback data to the main load control CPU.

Typical ratings for the switches are shown below:

Single Pole and Double Pole (by stacking)

240 VAC

60 AMPS resistive; 1.5 HP

Size: approx 1″×0.5″×0.5″

Short Circuit Rating: 5 kA

FIGS. 2 and 3 shows an architecture that performs load management on individual circuits within a facility. One or more individual circuits can be controlled in an on/off fashion to allow the total peak load to be reduced to match the capacity of the alternate power source. The control switches are centrally managed by load management controller that allows the user to set the priority of all loads via a User Interface as well as indicate the types of loads connected, percentage of system capacity used, status of all loads controlled and to indicate the total capacity of the alternate power source. The load switching is accomplished by the use of miniature power switches that can be retrofitted to an existing electrical distribution panel describe previously. An existing electrical distribution panel can consist of either individual circuit breakers or fuses for each circuit. The existing load wire is removed from the circuit breaker or fuse, and is inserted into a clinch type push-in receptacle on the power switch. A flexible pig-tail wire with spade terminal, which protrudes from the power switch, is then inserted into the existing circuit breaker or fuse, thus allowing remote on/off control of that circuit.

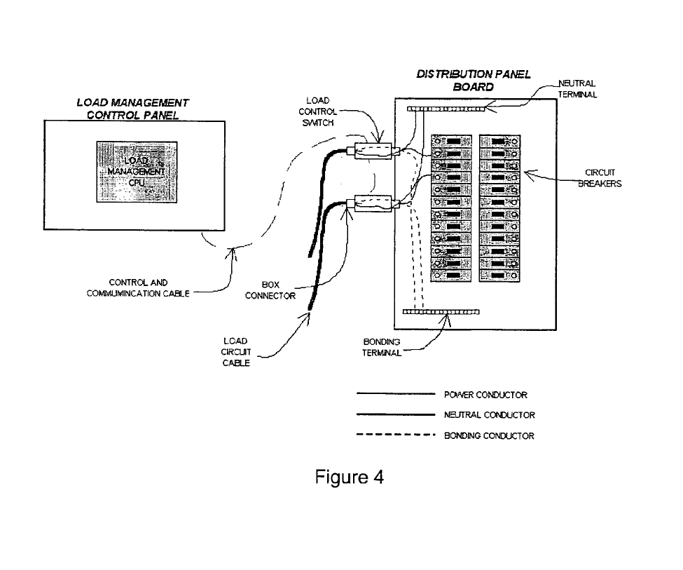

FIG. 4 show an alternative method of installing the load control switches, externally to the distribution panel. This method would utilize the same latching switch unit incorporated into a housing which can be fastened to the electrical panel through a knockout hole and be held in place with an industry standard nut. The circuit wiring would be completely pulled out of the panel, the load control switch would be installed in the opening left by the wire, then the existing wire ground and neutral conductors would be feed though the load control switch unit and re-terminated on the appropriate terminals. The hot conductor would then be terminated on the terminal provided in the load control switch and the hot lead affixed to the load control switch would be terminated on the circuit breaker or fuse in the distribution panel.

The control signals to interface with the main load management panel CPU will be via the same industrial network connection, which will allow the load control switches to be daisy chained together to minimize the amount of control wiring, connection for the control signals will be made via modular plugs and sockets provided on the load control switches.

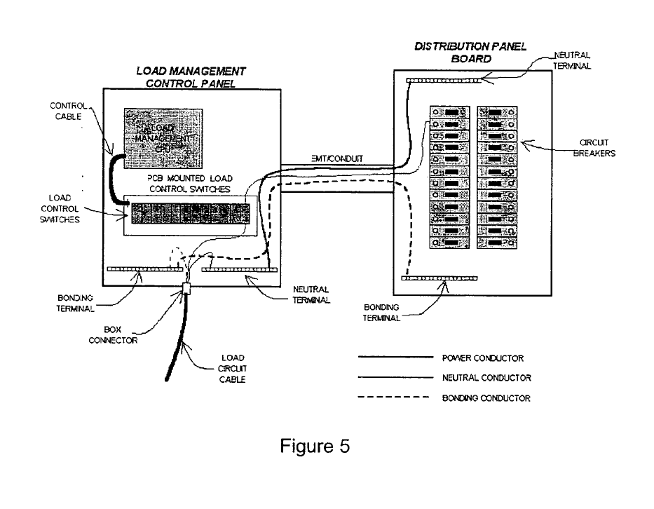

FIG. 5 illustrates another option, where the load control switches are located within the main load management panel. In this instance, the circuits to be controlled via the load management system are fed though the load control panel before the circuits are terminated in the distribution panel. There are several variations of this connection scheme for the routing of the conductors. For the method illustrated, the load management panel is provided with bond conductor and neutral conductor terminal bars for the connection of the circuit bonding and neutral conductors. These terminal bars are connected to the distribution panel neutral and bonding terminal with the appropriate sized conductors (based on the number of circuits installed in the load management panel). The circuit hot conductors are terminated on the load side of the load control switches mounted in the load management panel, the line side of the load control switches are then wired to the appropriate circuit breaker in the main distribution panel.

In this arrangement there is no need for a daisy chain network to control the load switches as the can be directly controlled from the main control board. This simplifies some of the control wiring and complexity of the overall system. Circuit load control switches become dedicated to the to specific controller outputs. In the networked arrangements the load control switches will have to be individually addressed so the CPU is aware of the circuits under control.

The overall system process includes several different concurrent processes as follows: a) Data acquisition and analysis (continuous system learning and adapting algorithm), b) Real time clock and calendar, c) Load control algorithm, and d) Remote input handling (override inputs from user/utility, generator).

The data acquisition and analysis process handles the adaptive features of the load control system which will allow the system to continuously update the profile of the one or more loads under control based on feed back from those loads. The system monitors the following parameters: a) time of day of operation, b) frequency of operation and duty cycle time then use these values to compute time dependant priority adjustment factor (TDPAF). The system also monitors the rate of energy used by a particular load and use this information to automatically set range limits under which the load would be disconnected and reconnected based on the power consumption limits imposed by operating from an on-site generator or limit peak hours from an electricity provider. These range limits are referred to as load weighting factors (LWF) for each load under control. The load control algorithm controls the total energy demand applied to the system. The algorithm uses the TDPAF and LWF from the data acquisition algorithm in combination with user programmed priority weight factors (UPWF) to shed load when required to by various control circumstances; this process is referred to as the utility function of the load control algorithm. The control circumstances are: a) system power supplied by generator of limited capacity, b) the electricity provider has limited the capacity a customer can consume, the energy rates (where the cost of energy is a function of time of day) for peak time are in effect. The utility function uses the values of TDPAF, LWF and UPWF in combination with the load constraints to maximize the convenience of the user under limited power conditions. Representing the weighting factors as numerical data and applying mathematical formulas to assign a priority level in relation to the other loads at any given time of day or year accomplish this. Different utility functions apply to each limited power situation and hence different load priorities may be assigned depending on the load constraint condition.

The system incorporates user control inputs. This will include the initial setup of the UPWF by the user that provides the initial conditions for the load control algorithm while allowing load priorities to be overridden by the user or the electricity provider. These actions may be received from a user interface or via a remote communications input. In the event that the system priorities are overridden by an external input, the system will attempt to compensate by dropping low priority loads if available. If the system is operating from a specific limited capacity supply such as an on-site generator, overrides will not be allowed if the available capacity is exceeded, i.e. no loads are available to shed in place of the called upon load.

The system incorporates a real time clock and calendar which all processes use as a time stamp and time basis for logging and updating the adaptve priority scheme and relating load priority to time of day operation.

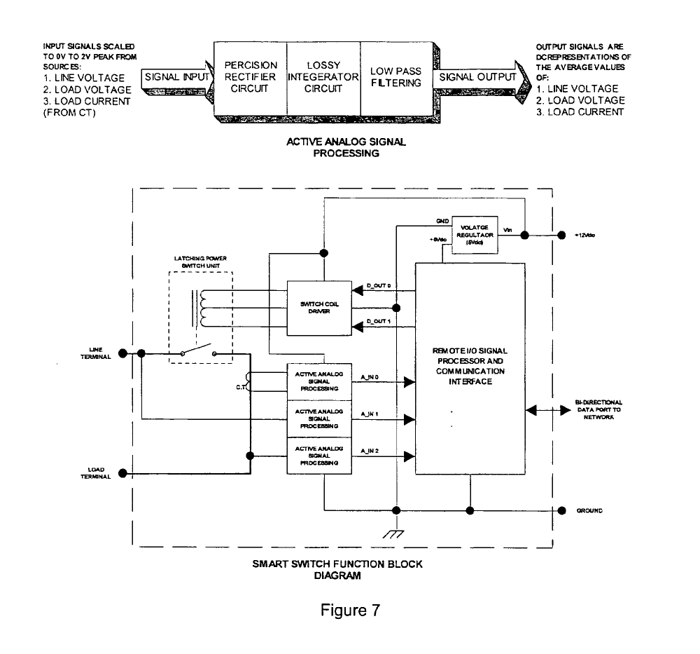

Illustrated in FIG. 7 is one possible solution for the smart load control switches. The main elements of the illustrated load control switch are; the latching power switch unit; signal processing and filters; switch control drivers; remote signal processor and communications interface to data network; voltage regulator for digital circuits. In this particular solution, the load control switch would incorporate the circuitry to monitor the load current through the device, the load voltage and the line voltage.

The AC voltage and current signals are converted the DC signals that represent the average voltage and current values supplied to the load device. These DC signal are read by the A/D ports of the remote I/O signal processor and stored in internal memory where they are read by the main system controller via the data network connection. The main control unit (located remote to the load control switch) would then use the data retrieved from the load control switch to make decisions about the status of the switch, ie. If the switch is on monitor the load current to ensure the capacity of the switch is not exceeded, compare the line and load voltage for excessive voltage drop across the switch contacts and evaluate the condition of the switch based on these signals, whether the switch has failed to open, or failed to close, or if the contacts are presenting excessive resistance to the circuit.

The current signal is derived from a current transformer (C.T.), which produces a secondary current directly proportional to the load current. This proportional current id feed to a resistive network which produces an AC voltage signal, the AC signal is then processed through the active signal processing. The active signal processing utilizes op-amps to perform several functions, the first is a precision half wave rectifier, the half wave rectified signal is then processed by a lossy integrator circuit. The integrator circuit produces a voltage signal with a low frequency component that represents the average value of the rectified input signal. Finally a low pass filter removes the higher frequency component of the signal and produces a DC signal that is proportional to the average value of the RMS value of the AC input signal. The active signal processing sections are identical for the line and load voltage sensing with the exception of the front end, where the input voltage to the signal processing will be via a simple resistive voltage diver network.

The Latching switch unit is controlled via the line driver unit, which provides the higher power required to change the switch position. The signals to the line drive are provided via the remote I/O processor digital outputs, which reflect the state of internal memory bits. The memory bits are controlled via the data network by the main control unit, thus giving the main controller the ability to switch the load control switch position via the data connection.

This provides one possible solution for the smart switches, there are other methods, one might employ a low cost digital signal processor or micro controller in place of the remote I/O and communications controller. In this instance the input signal filtering could be simplified as the as digital signal filtering techniques could be applied. The load control switches would calculate and evaluate there own operating status as opposed to the main controller having to do these functions, the switch would simply be poled by the main controller for the status information of switch and controlled via the data network. Also the proposed solution does not include any zero crossing detection circuits, however, if local micro controllers are employed in each switch this ability to employ zero crossing detectors and switching becomes more easily implemented.

The overall system of FIG. 6 is now described in further detail.

The priority function is the main loop of the load management software program. This function will determine the order in which loads are shed or picked up based on system demand by using the data acquired to determine the relative priority of each load under control based on the information gathered from the other algorithms.

The utility function acts as the core of the data acquisition algorithm; this is the main function, which will assemble the time of day, load frequency of operation, load duration, user factor, power supplier factors into a database for use by the priority function. Where this database of variable elements is continuously updated based on the overall power system usage, user and power system input. The load based input sources are used by the utility function to generate a numeric representation of the importance of a particular load relative to the time of day (based on the real time clock). These utility values will be continually averaged over time to compensate for long duration (seasonal) changes. The utility function will use the real time clock algorithm to establish which time periods to update in the database for each load utility value. The priority function will also use the real time clock to synchronize with the correct values from the utility function database. Inputs to the utility function from the user or power supplier will be applied as direct weighting factors to utility function data and are not computed into the time averaged data but remain as constants that are applied to the utility database values sent to the Priority function.

The load control algorithm controls the actual switching loads on and off based on the following input information: overall system load, load limits imposed by power provider or generator size, overriding inputs from user or power provider and the load priority list establish by the priority function. The load control algorithm will attempt to maximize the user convenience by maintaining the loads of high utility and priority by shedding the lowest priority load first in a limited system capacity situation. As load priorities change thought the day the system will change the loads shed should a load with a low priority become a higher priority load as time progresses (i.e. Kitchen appliances during meal preparation time). In a user override situation the system will shed higher priority loads to allow the user-selected load to operate. Power provider overrides (while under utility power only) may take precedence over all other inputs to shed a particular load, this will depend on the power provider policy for customer load shedding and will be a user setup function as to whether the user or utility preference take precedence.

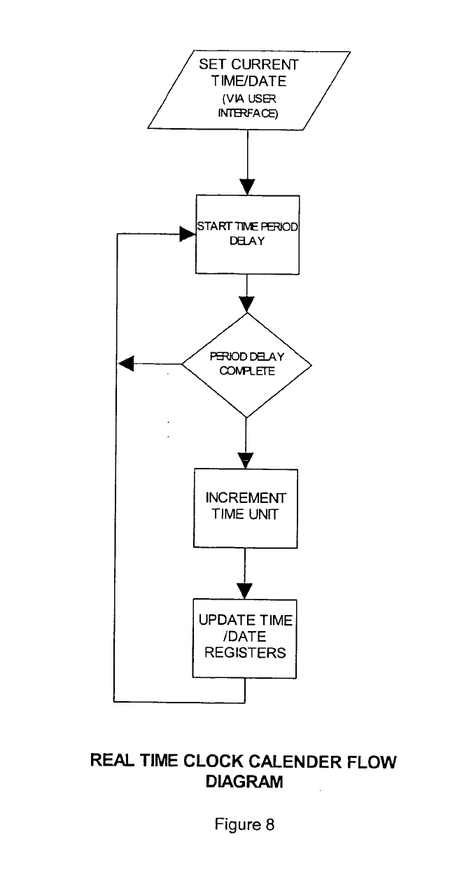

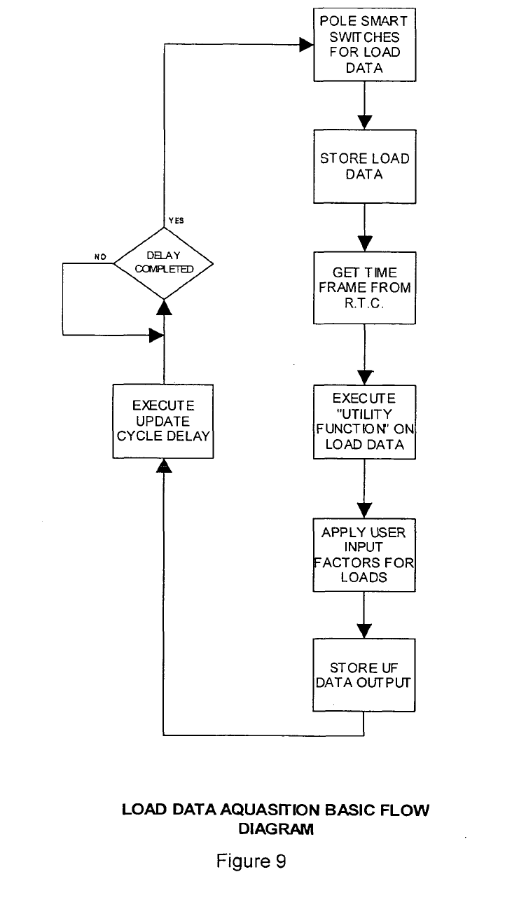

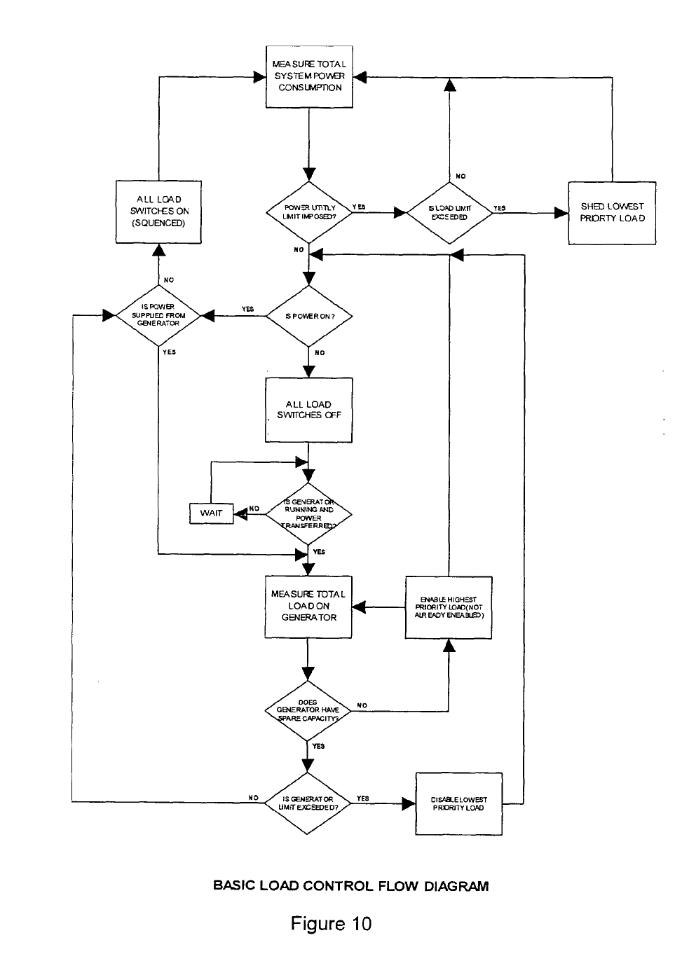

The basic algorithm for the real time clock calendar flow, the load data acquisition flow, and the basic load control flow are shown in FIGS. 8, 9 and 10 respectively.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A power load management system for regulating the energy demand from a distribution panel comprising:
switching means for selectively decoupling specific loads from a distribution panel in response to a demand limiting signal, the switching means also providing load feedback data; and,
a control unit for monitoring the load feedback data and operational parameters for providing the demand limiting signal in accordance with a power management algorithm.

2. The power load management system of claim 1, wherein the switching means includes a plurality of load control switches.

3. The power load management system of claim 2, wherein each load control switch is coupled between a circuit breaker in the distribution panel and load associated with the circuit breaker.

4. The power load management system of claim 1, wherein the operation parameters include time, date, user weighting factor, utility weighting factor, power source limit, utility limit, total system load and rate limit factor and the load priority is established by an time varying optimizing algorithm that maximises user convenience.

5. The power load management system of claim 1, wherein the control unit includes external inputs for allowing user and electricity provider override capability.

6. The power load management system of claim 2, wherein the load feedback data includes duty cycle data, frequency of operation data and power consumption data associated with the load under the control of that switch.

7. The power load management system of claim 1, wherein the control unit includes a main load control central processing unit for executing the power management algorithm.
